(19) United States
(12) Patent Application Publication
(10) Pub. No.: US 2017/0220706 A1
(43) Pub. Date: Aug. 3, 2017

(54) SYSTEMS, METHODS AND APPARATUS THAT EMPLOY STATISTICAL ANALYSIS OF STRUCTURAL TEST INFORMATION TO IDENTIFY YIELD LOSS MECHANISMS

(71) Applicants: Jacob J. ORBON, Cupertino, CA (US); Eric VOLKERINK, Palo Alto, CA (US)

(72) Inventors: Jacob J. ORBON, Cupertino, CA (US); Eric VOLKERINK, Palo Alto, CA (US)

(73) Assignee: VERIGY (SINGAPORE) PTE. LTD., Singapore (SG)

(21) Appl. No.: 13/822,625

(22) PCT Filed: Sep. 13, 2010
(86) PCT No.: PCT/US10/48656

§ 371 Date: Feb. 10, 2016

(30) Foreign Application Priority Data
Sep. 13, 2010 (US) PCT/US2010/048656

(51) Int. Cl. G06F 17/50

(52) U.S. Cl. CPC G06F 17/504; G06F 2217/10

(57) ABSTRACT

A method for statistically analyzing structural test information to identify at least one yield loss mechanism includes executing a plurality of instructions on a computer system. The executed instructions cause the computer system to perform the steps of: 1) identifying potential root causes for items of structural test information obtained for a plurality of semiconductor devices; 2) statistically analyzing the items of structural test information to identify at least one non-random device failure signature within the items of structural test information; and 3) identifying from the potential root causes a probable root cause for at least a first of the at least one non-random device failure signature.

### BACKGROUND

The following disclosure pertains to the design and manufacture of semiconductor devices and, more particularly, to systems, methods and apparatus for improving the yield and performance of such devices. The disclosed systems, methods and apparatus may be applied to various types of semiconductor devices, including, for example: individual semiconductor die (regardless of whether the die have been singulated from one or more wafers); multiple semiconductor die devices, such as system-in-a-package (SIP) or other stacked die devices; and packaged semiconductor devices.

When manufacturing semiconductor devices, the production yield is rarely 100%. There are a variety of failure mechanisms that contribute to this yield loss, some of which are random, and some of which are non-random. The non-random yield loss mechanisms can be systematic (due to process weaknesses or failures) or parametric (due to design weaknesses).

Traditional methods for detecting systematic and parametric yield loss mechanisms use either a spatial analysis approach or a test structures approach.

Spatial analysis approaches focus on faults or defects that affect an area of a semiconductor wafer in a non-random pattern. In some cases, the faults or defects may be detected using mathematic analysis of fault or defect clusters, as taught, for example, by R. E. Langford, G. Hsu and C. Sun in “The Identification and Analysis of Systematic Yield Loss”, 2000 IEEE/SEMI Advanced Semiconductor Manufacturing Conference and Workshop, pp. 92-95. However, these techniques suffer from the need to detect faults or defects using an optical inspection tool.

Spatial analysis approaches also include the use of Multiple Die Yield Analysis (MDYA) methods, as taught, for example, by Allan Y. Wong in “A Statistical Approach To Identify Semiconductor Process Equipment Related Yield Problems”, 1997 Workshop on Defect and Fault-Tolerance in VLSI Systems table of contents, pp. 69-75. However, MDYA methods are very limited, because they work at the die level and only use die pass/fail criteria to detect systematic issues. MDYA methods also convey total systematic yield loss as a percentage, and thus, cannot be used to categorize different systemic yield loss mechanisms in a population of devices.

Test structures can be used to identify systematic problems, but these approaches can only be used in a deductive reasoning type flow. As a result, they are less useful in identifying new systematic mechanisms, because a failure mechanism must be hypothesized, a test structure must be built, and then the hypothesis must be tested. This is a long and arduous process that leads to a lot of risk during high volume manufacturing. In addition, test structures are not practical for identifying all systematic problems. An example of a test structures approach is disclosed by M. Karthikeyan, S. Fox, W. Cote, G. Yeric, M. Hall, J. Garcia, B. Mitchell, E. Wolf and S. Agarwal in “A 65 nm Random and Systematic Yield Ramp Infrastructure Utilizing a Specialized Addressable Array with Integrated Analysis Software”, 2006 IEEE International Conference on Microelectronic Test Structures, pp. 104-109.

Spatial analysis and test structures techniques also require a fairly strong signal to detect systematic problems.

### BRIEF DESCRIPTION OF THE DRAWINGS

Illustrative embodiments of the invention are illustrated in the drawings, in which:

FIG. 1 illustrates an exemplary computer-implemented method for identifying systematic or parametric yield loss mechanisms;

FIG. 2 illustrates an exemplary system for implementing the method shown in FIG. 1;

FIG. 3 illustrates an exemplary flow of a semiconductor production process, in conjunction with an implementation of the method shown in FIG. 1 or the system shown in FIG. 2;

FIG. 4 illustrates an exemplary flow of a semiconductor design and production process, in conjunction with an implementation of the method shown in FIG. 1 or the system shown in FIG. 2;

FIG. 5 illustrates an exemplary process for identifying production groups or lots having semiconductor devices associated with a particular non-random device failure signature;

FIG. 6 illustrates use of the method shown in FIG. 1 in a first exemplary method for improving a FMEA process;

FIG. 7 illustrates use of the method shown in FIG. 1 in a second exemplary method for improving a FMEA process;

FIG. 8 illustrates an exemplary GUI for displaying an exemplary output of the method shown in FIG. 1 or the system shown in FIG. 2; and

FIG. 9 illustrates an exemplary computer system for implementing the method shown in FIG. 1, 6 or 7, or the system shown in FIG. 2.

It is noted that, in the following description, like reference numbers appearing in different drawing figures refer to like elements/features. Often, therefore, like elements/features that appear in different drawing figures will not be described in detail with respect to each of the drawing figures.

### DETAILED DESCRIPTION

Disclosed herein are systems, methods and apparatus that rely on the net-level electrical behavior of a semiconductor device to detect (or identify) systematic and parametric yield loss mechanisms. In particular, the systems and methods employ statistical analysis of structural test information to identify yield loss mechanisms.

For purposes of this description, “structural test information” is defined to include items of information derived from tests that determine whether structures in a semiconductor device are present, properly connected, and operational, regardless of whether the structures perform their intended function(s). Structural test information is often obtained from Built-In Self-Test (BIST) hardware or other Design for Testability (DFT) structures, such as scan chains, which structures enable the capture of structural test information from hundreds, thousands or even millions of observation points (e.g., scan-enabled flip-flops or latches) within a device under test (DUT). Structural test information can be qualitative (e.g., indicative of a pass or fail) or quantitative (e.g., indicative of a particular clock frequency or voltage at which a DUT passes or fails a test). Structural test information can enable the detection of both visible and non-visible faults. Structural test information can also be used to identify faults leading to failed devices, as well as faults or performance issues that have not yet led to failed devices.

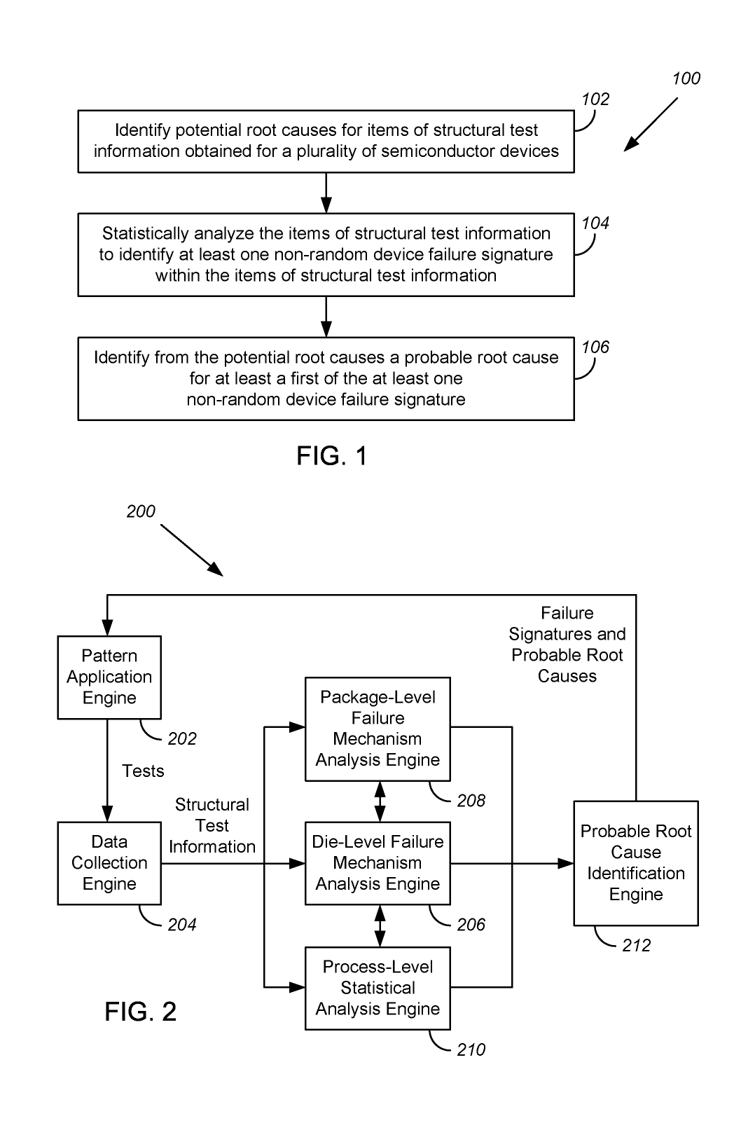

In the above context, FIG. 1 illustrates an exemplary computer-implemented method 100 for identifying systematic or parametric yield loss mechanisms. The method 100 comprises 1) identifying potential root causes for items of structural test information obtained for a plurality of semiconductor devices (at block 102), 2) statistically analyzing the items of structural test information to identify at least one non-random device failure signature within the items of structural test information (at block 104), and 3) identifying from the potential root causes a probable root cause for each of one or more non-random device failure signatures. The potential and probable root causes may be, for example, production process steps or variations, design process steps or variations, particular cones of logic, or particular pieces of equipment used to produce a group of semiconductor devices.

For purposes of this description, a “device failure signature” is defined to be a collection of structural test data items indicating test failures, which test failures may indicate 1) a device failure, or 2) a performance threshold failure (e.g., a failure to perform at a certain clock frequency).

Having briefly introduced the method 100, various details and permutations of the method 100 will now be discussed, in the context of an exemplary computer system 200 (FIG. 2) for implementing the method 100. By way of example, the system 200 is shown to comprise six subsystems, including a pattern application engine 202, a data collection engine 204, a die-level failure mechanism analysis engine 206, a package-level failure mechanism analysis engine 208, a process-level statistical analysis engine 210, and a probable root cause identification engine 212. As will become clear from the following description, some embodiments of the system 200 may comprise more, fewer or different subsystems.

Turning now to the pattern application engine 202, the engine 202 may generate tests using an automatic test pattern generator (ATPG) or pro-actively. If the tests are generated pro-actively, they can be generated dynamically (e.g., based on previous yield learning results) or statically (e.g., based on a test engineer's belief that particular yield loss mechanisms exist). The tests may comprise test patterns, control signals and other stimuli that are applied to a plurality of semiconductor devices through, for example, automated test equipment (ATE) or BIST hardware. By means of the ATE or BIST hardware, the test patterns may be loaded into and launched from one or more scan chains or other DFT structures of the semiconductor devices. Responses to the launched test patterns may then be captured in and shifted out of the scan chains or other DFT structures.

As a result of applying the test patterns to the scan chains or other DFT structures, structural test information is generated. The structural test information may comprise, for example, qualitative data (e.g., pass/fail data) or quantitative data (e.g., performance data collected in response to path delay or transition delay test patterns). The structural test information may be obtained from scan-enabled flip-flops or latches, or may be collected using BIST-type structural test techniques. The structural test information may be collected by the data collection engine 204, which engine 204 may in some cases process or derive measurements (e.g., timing measurements) from structural test information. In some cases, the structural test information may be processed, for example, by converting information collected in a pin/cycle count format to information having a pattern/chain/bit format, or by converting or annotating information having a pattern/chain/bit format to (or with) information indicative of physical locations of failures. This processed and derived information is also considered structural test information for purposes of this disclosure.

In some cases, either or both of the pattern application engine 202 and the data collection engine 204 may be incorporated into, or be in communication with, ATE or BIST hardware.

The first of the failure mechanism analysis engines is a die-level failure mechanism analysis engine 206. The engine 206 has a structural test information input and a root cause output, and is configured to identify die-level potential root causes for items of structural test information. That is, the engine 206 identifies potential root causes versus their effects (e.g., versus structural test information fails or performance deviations) at the die level. The potential root causes may be identified, for example, by parameterizing a model of potential root causes. This speeds up the identification of systematic and parametric yield loss mechanisms at the process level by placing a focus on yield loss attributers.

The die-level potential root causes may be identified for both individual and multiple semiconductor die devices.

In some cases, the failure mechanism analysis engine 206 may identify potential root causes for items of structural test information by identifying physical locations of failed scan chain elements (e.g., locations of flip-flops or latches that captured an unexpected logic state). In other cases, the engine 206 may identify potential root causes by identifying cones of logic that drive the failed scan chain elements, and then optionally determining physical locations of the identified cones of logic. The physical locations of the identified cones of logic may be defined, for example, in terms of coordinates of imaginary boxes that bound the cones of logic, or in terms of coordinates of one or more discrete elements within the cones of logic. The identified cones of logic or physical locations may then be correlated with more fundamental root causes, such as design process causes (e.g., design rules) or production process causes (e.g., production process steps or variables). A tool for identifying such physical locations and bounding boxes of particular cones of logic is the YieldVision™ software offered by Verigy, Ltd.

The engine 206 enables the system 200 to deduce, for example, that a certain logic cone has a failure, or that certain metal layers are misaligned.

The second of the failure mechanism analysis engines is a package-level failure mechanism analysis engine 208. The engine 208 has a structural test information input and a root cause output, and is configured to identify package-level potential root causes for items of structural test information. The engine 208 may be used to identify, for example, potential inter-die or die-to-package root causes, such as misalignments of through-silicon vias (TSVs) in a SIP. Often, the engine 208 can build upon the information generated by the engine 206, such as information pertaining to the physical locations of failed scan chain elements or cones of logic.

The process-level statistical analysis engine 210 is configured to statistically analyze the items of structural test information generated by the data collection engine 204 and identify at least one non-random device failure signature within the items of structural test information. The engine 210 can perform its analysis in the context of qualitative data, quantitative data or both, by correlating items of one or both types of information across multiple observation points within a plurality of semiconductor devices. The correlations may be undertaken at both die and package levels. Correlation techniques can be used, for example, to compare quantitative data such as delay or frequency measurements on multiple observation points (e.g., scan enabled flip-flops or latches) within a group of semiconductor devices, to detect and quantify non-random device failure signatures. The techniques used for correlating quantitative data may comprise, for example, analysis of variance (ANOVA) techniques, t-test techniques, f-test techniques, or other statistical analysis techniques. Correlation techniques may also include statistical techniques applicable to qualitative data, such as Chi-square techniques. For example, Chi-square techniques can be used to compare pass/fail patterns on multiple observation points and detect non-random device failure signatures. Chi-square techniques may also be used to identify statistical trends, such as, “upon seeing failure x and failure y, the likelihood of seeing failure z increases”.

The engine 210 may perform its statistical analysis on items of structural test information alone, or in the context of potential root causes identified by the failure mechanism analysis engines 206, 208. In the latter instance, and by way of example, statistical analysis may be performed on a subset of data that has been filtered based on common or similar potential root causes. Such common or similar potential root causes may include: a common cone or cones of logic; proximate physical locations; a common device layer; common design rules; or common process steps.

The engine 210 may determine whether a device failure signature is non-random in various ways. For example, in the case of Chi-square analysis, Chi-square distributions may indicate whether a device failure signature is non-random. In other cases, statistical significance (or non-randomness) of a device failure signature can be determined, for example, by creating a histogram of counts versus device failure signatures. Those signatures that occur in devices most frequently (e.g., those in the top 5%) can be considered non-random, and other device failure signatures can be considered random. Non-randomness may be determined, for example, based on fixed or relative thresholds.

The probable root cause identification engine 212 combines the data from the lower levels of the system 200 and is configured to identify a probable root cause for at least a first of the at least one non-random device failure signature. In some cases, the engine 212 may identify probable root causes for all non-random device failure signatures, or for the most statistically significant ones of the non-random device failure signatures, thereby characterizing and quantifying overall yield attribution. Indirectly, the engine 212 parametrizes a model that helps a user of the system 200 understand what actions need to be taken depending on the issues. For example, instead of simply generating a string of signature bits, the engine 212 can indicate to the user that a misalignment between metal 2 and metal 3 causes a problem, or that a misalignment in TSVs between dies 3 and 4 in a SIP causes a problem, or that a particular design library cell causes a problem. These conclusions can then be conveyed to a user by, for example, displaying the conclusions on a graphical user interface (GUI) or generating a printed report.

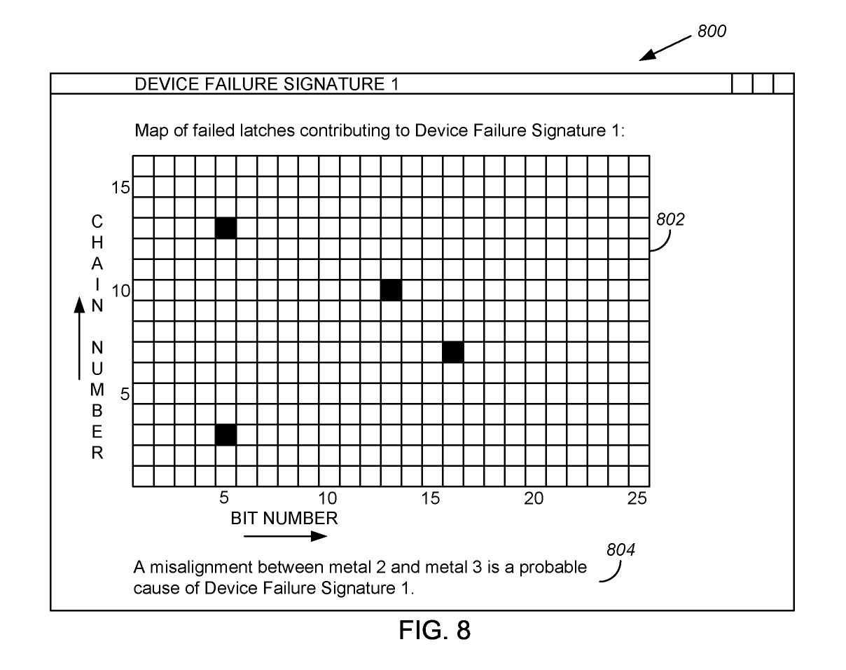

An exemplary GUI 800 for displaying an output of the method 100 (FIG. 1) or system 200 (FIG. 2) is shown in FIG. 8. The GUI 800 provides a map 802 of failed latches contributing to a “Device Failure Signature 1”. By way of example, the map 802 illustrates failed latches as darkened boxes in an x/y grid. The y-axis of the map 802 is labeled “CHAIN NUMBER” and identifies the scan chains of a DUT by scan chain number. The x-axis of the map 802 is labeled “BIT NUMBER” and identifies the various bit positions in each of the DUT's scan chains. It is noted that, in a real world example, a DUT would likely have many more scan chains and scan chain bits than what is shown in FIG. 8, and some of the DUT's scan chains might have different numbers of bits. Also, zoom, scroll or other mechanisms would likely be employed to navigate between different resolutions or subsets of a DUT's scan chains and scan chain bits. However, regardless of the number of scan chains and scan chain bits in a particular DUT, the GUI 800 also indicates a probable cause 804 of the Device Failure Signature 1—i.e., that “A misalignment between metal 2 and metal 3 is a probable cause of Device Failure Signature 1.” In this manner, a user of the GUI 800 can readily determine what action needs to be taken to eliminate (or reduce the frequency of appearance of) the “Device Failure Signature 1”.

In some embodiments of the method 100 (FIG. 1) or system 200 (FIG. 2), items of structural test information may be statistically analyzed in real time, as they are collected, to search for new non-random device failure signatures. This can be done, for example, by supplementing a previously analyzed collection of structural test information with newly acquired structural test information, or by analyzing a set of structural test information collected over a particular period of time or set of conditions. The set of structural test information can be analyzed anew as new structural test information is added, or may be analyzed by eliminating information that corresponds to previously-identified non-random device failure signatures and root causes. By re-analyzing a data set as new information is added, or by analyzing data sets for a progression of data windows, process drifts (trends) and other yield loss events that affect the profitability of a production manufacturing process can be identified. This information can then be used to control or improve the production process. This, in turn, can lead to improved yield, higher performance devices, or devices with improved reliability.

The method 100 and system 200 can also be used in a proactive fashion, in conjunction with the formulation and analysis of deliberate experiments in the design or production processes for a semiconductor device. For example, a step or variable in a process window may be varied for different ones or groups of a plurality of semiconductor devices. The variations in the process window may then be enumerated as potential root causes, and a determination may be made as to whether one or more of the variations is a probable root cause of particular items of structural test information. In this manner, a collection of device failure signatures corresponding to particular process steps or variables can be logged. The signatures can then be used as templates that are compared to routine manufacturing test data (e.g., structural test information) to search for indications of process window drift. The templates can also be compared to historical data, for the purpose of assessing past performance of, or trends in, a production process. In a similar fashion, different ones or groups of semiconductor devices may be produced with a number of variations in a design, and the method 100 or system 200 can be used to identify non-random device failure signatures tied to particular design variations.

Regardless of how the method 100 or system 200 is implemented, the non-random device failure signatures resulting from its analyses can be stored to a signature library, thereby enabling design or production issues to be identified more quickly in the future, based on prior analyses.

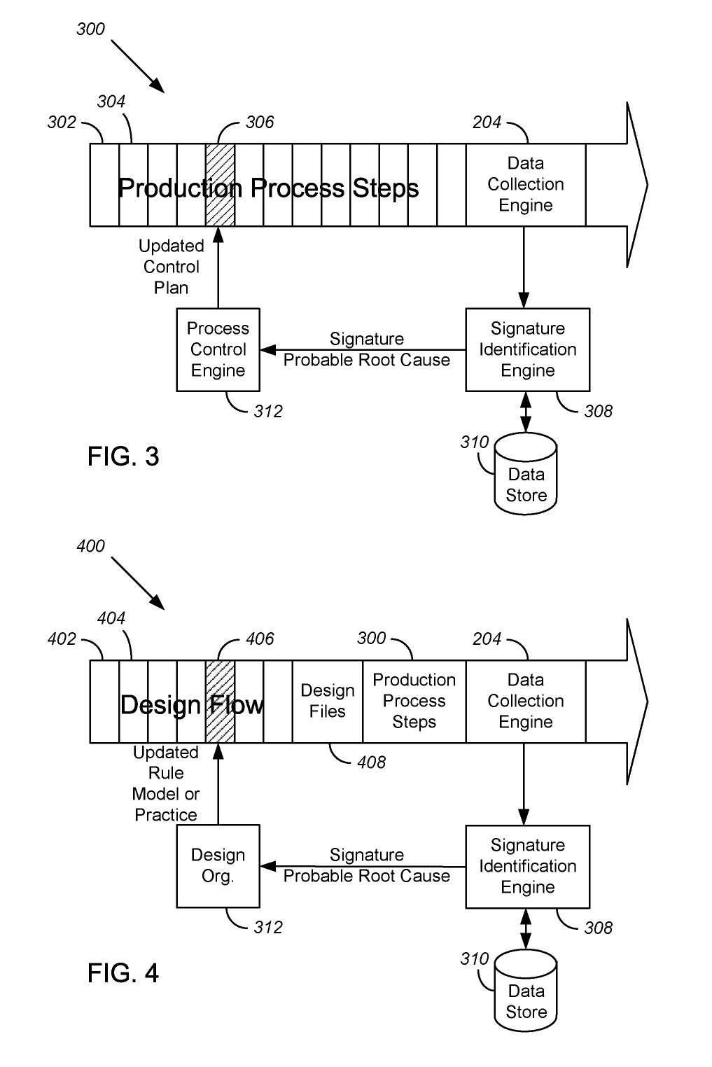

FIG. 3 illustrates an exemplary flow of a semiconductor production process 300 including process steps 302, 304 and 306. Each of the process steps 302, 304, 306 operates on particular structures, such as particular cones of logic, logic elements, or layers of a plurality of semiconductor devices. Although 13 steps are shown in the process 300, a typical semiconductor production process may have hundreds of steps, and some of the steps may have several important variables. In accord with some embodiments of the method 100 and system 200, structural tests are applied to the devices and structural test information is collected. By way of example, the structural test information is shown to be collected by the data collection engine 204 of the system 200 (FIG. 2). The structural testing may occur at the end of the production process, or at one or more stages within the process. In some cases, potential root causes for the structural test information may be identified, and the items of structural test information can be statistically analyzed for non-random device failure signatures by signature identification engine 308, which engine 308 may in some cases include the engines 206-212 shown in FIG. 2. Data being analyzed, or conclusions reached, may be stored in a data store 310.

The potential or probable root causes for the structural test information analyzed by the signature identification engine 308 may comprise any of the production process steps or variables 302, 304, 306, as well as other causes. If one or more of the production process steps or variables are identified as a probable root cause for a non-random device failure signature, a user may be alerted of this fact by, for example, a graphical user interface (GUI) of a computer system. Or, a process control engine 312 may be caused to automatically alter a step or variable in the production process. Automatic alteration of a step or variable may be appropriate where, for example, the probability associated with a probable root cause meets a particular statistical threshold. Automatic alteration of a step or variable may also be appropriate when the correspondence between a non-random device failure signature and a probable root cause has already been confirmed through deliberate experiments or by a user.

FIG. 4 illustrates an exemplary flow of a semiconductor design and production process 400 that precedes the semiconductor production process 300. The design process 400 includes design steps 402, 404 and 406, which steps 402, 404, 406 may include design or layout rules or practices. The design process 400 may culminate in a set of design files 408, which design files 408 are then provided to the production process 300. The data collection engine 204 and signature identification engine 308 from FIG. 3 are also shown in FIG. 4, and may perform the same or similar functions. However, in the context of what is shown in FIG. 4, a probable root cause corresponding to a non-random device failure signature is fed back or displayed to a design organization, so that an appropriate adjustment may be made to a device's design or layout. The effect of the adjustment(s) can then be evaluated for improved yield, performance or reliability.

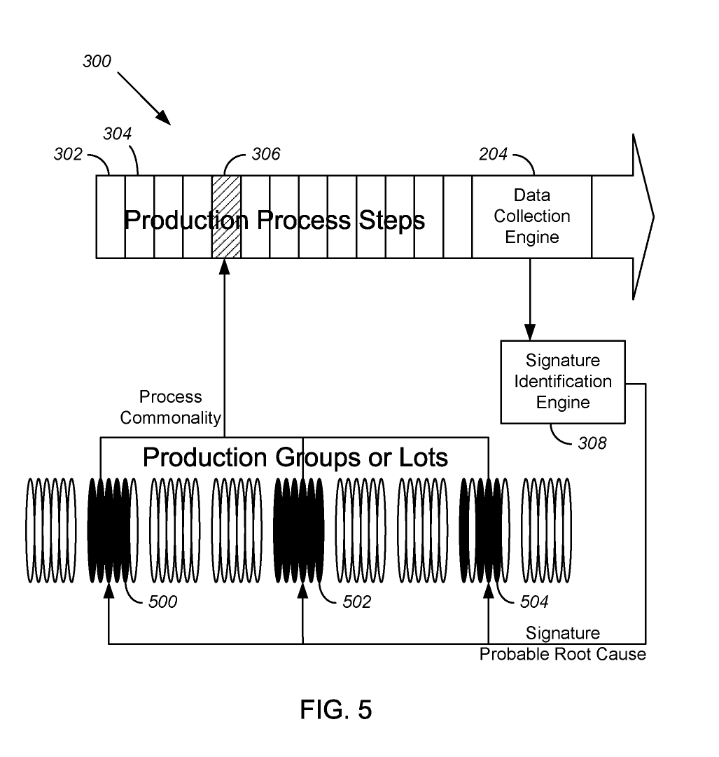

In some cases, and as shown in FIG. 5, a non-random device failure signature, once identified, may be used to search for at least one other semiconductor device associated with the signature. Production process steps or variations that are common to the semiconductor devices associated with the signature may then be identified, and a probable root cause for the signature may be identified from among the common production process steps or variations. In some cases, the process illustrated in FIG. 5 may be used to identify production groups or lots 500, 502, 504 with which the devices are associated, which production groups or lots 500, 502, 504 may be used to identify, for example, particular process steps or variations to which the production groups or lots were subjected (e.g., a process commonality). The process commonality may be, for example, a common state of a process variable, or a common piece of equipment to which the production groups or lots were subjected.

The devices associated with a particular non-random device failure signature may be further tested. Tests for this additional testing may be selected automatically or interactively. For example, in some cases, a test program for a semiconductor device may be automatically updated to include tests for further evaluating a probable root cause of a device failure signature. In other cases, tests may be launched interactively, using a test editor or debug program.

To the extent devices associated with a particular non-random device failure signature can still be sold, the devices may be monitored or tested in the field, thereby enabling statistically significant reliability or performance issues to be correlated with a particular non-random device failure signature.

Some of the potential advantages of the method 100 and system 200 have already been discussed. These and other advantages are summarized below.

One advantage of the method 100 or system 200 is that it allows systematic and parametric yield loss mechanisms to be detected from an existing stream of structural test information. That is, in some embodiments, the method 100 and system 200 enable the detection of systematic and parametric issues based on structural test information that has already been acquired for other purposes. In some cases, systematic and parametric yield loss mechanisms can be identified in real time, as the structural test information is collected. This speeds up the yield attribution process.

The method 100 and system 200 also enable the identification or detection of systematic and parametric issues from actual product die or devices. Still further, the method 100 and system 200 provide a high degree of sensitivity to multiple different yield loss mechanisms, based on structural test information derived from thousands or millions of observation points per die or device. The method 100 and system 200 also enable the identification or detection of systematic or parametric issues in the presence of random noise using, for example, advanced statistical analysis techniques such as Chi square methods. In addition, the method 100 and system 200 do not require dedicated test structures on-chip or on-wafer (other than DFT structures that already exist for other purposes).

The method 100 and system 200 can be applied to individual semiconductor die, or to semiconductor devices containing multiple semiconductor die, such as SIP devices. The method 100 and system 200 can also be applied to other high level integration components that allow statistical analysis of structural test information, such as printed circuit boards or other components that have been provided with DFT structures.

In some cases, fail rates can be measured for semiconductor devices sharing a non-random device failure signature, and these fail rates can be used to prioritize yield enhancement activities in a device's production or design processes, leading to faster yield improvement.

In addition to detecting the presence of systematic and parametric yield loss mechanisms, in general, the method 100 and system 200 can be adapted for use in Failure Mode and Effects Analysis (FMEA).

FMEA is a critical part of the semiconductor manufacturing process. This is because the complex nature of semiconductor manufacturing, and the large dollar volumes of unfinished material that are in process at any particular time, require a manufacturer of semiconductor devices to construct and utilize a formal control plan for reducing process drift and failed material. The FMEA process helps a manufacturer develop such a control plan.

The FMEA process is based on estimates of the Detection (D), Occurrence (O) and Severity (S) of process drift.

“Detection” refers to the ability of the manufacturer to detect process drift. Low values of Detection indicate that undetected process drift can occur. Low values of Detection can be due to: 1) Lack of a suitable metrology approach; 2) Poor accuracy or precision of the metrology approach; or 3) Large Work-In-Process (WIP) inventory between a process variable/control point and its metrology point.

“Occurrence” refers to the frequency that a particular process variable drifts during routine manufacturing.

“Severity” refers to the impact of process drift.

Consider, for example, a semiconductor device that contains over a billion transistors, all of which are smaller than the wavelength of visible, ultraviolet (UV) or deep-UV light. The process to manufacture such a semiconductor device might include more than 400 process steps, with more than ten critical process variables per step. Clearly, the number of yield loss mechanisms to which such a device and process are subjected is significant. Because of this large number of yield loss mechanisms, and because of the existence of random noise from which the yield loss mechanisms need to be distilled, yield loss estimates for such a semiconductor manufacturing process have typically suffered from poor accuracy and precision, which has in turn led to 1) ad hoc estimates of process variable specification limits, and 2) ad hoc and erroneous estimates of FMEA Detection, Occurrence and Severity scores.

In the past, yield loss has been analyzed and estimated based on raw pass/fail results or electrical failure bins. However, this sort of analysis fails to consider the three-dimensional nature of the semiconductor manufacturing process, including the various layers that define an individual semiconductor die, and the interconnect that joins multiple semiconductor die (or joins a die and its package). This makes it very difficult to determine the effects of a yield loss mechanism and estimate yield loss.

Also in the past, estimates of Detection, Occurrence and Severity of process drift have often been made based on the perceptions of an engineer who is responsible for a particular process step. These sorts of estimates are not accurate, and the complex relationships between the three-dimensional manufacturing process and the electrical test pattern architecture of the test program make such estimates difficult to update and fine-tune.

The method 100 (FIG. 1) and system 200 (FIG. 2), or variants thereof, can be used to improve the FMEA process by providing accurate and precise measurements of pass/fail rates at the scan chain/bit level, and by attributing pass/fail rates to particular process steps and variables. By analyzing pass/fail rates at the scan chain/bit level, observability of failure mode effects is improved by up to a factor of a million over traditional approaches. Using this factor-of-a-million improvement in observability, the method 100 and system 200 provide unprecedented ability to separate individual yield loss mechanisms. This, in turn, provides the ability to measure the Detection, Occurrence and Severity of process drift and other failure mechanisms with unprecedented accuracy and precision.

One of the most powerful aspects of the method 100 and system 200 is the ability to filter out unrelated failure modes to establish fail rates due to specific process variables. This is possible due to the identification of potential root causes for items of structural test information, which root causes may be identified by first identifying 1) cones of logic that drive failed scan chain elements, or 2) physical locations (e.g., two- or three-dimensional locations) of the scan chain elements or cones of logic. The identified cones of logic or physical locations can then be correlated with particular design or production process steps or variables.

In some FMEA-related uses of the method 100 or system 200, items of structural test information may be statistically analyzed to identify and remove information attributable to random yield loss mechanisms. Information attributable to non-random yield loss mechanisms may then be analyzed to determine root causes for items of structural test information corresponding to individual chains/bits, or for non-random device failure signatures corresponding to multiple items of structural test information.

The method 100 and system 200 also enable accurate and precise measurement of specification limits for process variables. That is, in the past, it has been common in semiconductor manufacturing to use +/−10% as a default specification limit for process variables. However, scan chain/bit based yield measurements can be used to set specification limits based on the actual failure mode effects of individual process variables.

Using the non-random device failure signatures and probable root causes identified by the method 100 or system 200, a feedback loop may be established for correcting issues in a manufacturer's FMEA analysis and control plan. The method 100 and system 200 also enable long-term monitoring of fail rates to confirm specification limits, track field performance, and analyze and confirm the impact of process drift of multiple specified variables (including interactions of same).

In short, the method 100 and system 200, and variants thereof, can convert the FMEA process from a subjective and unmeasurable process to a measurable and correctable process.

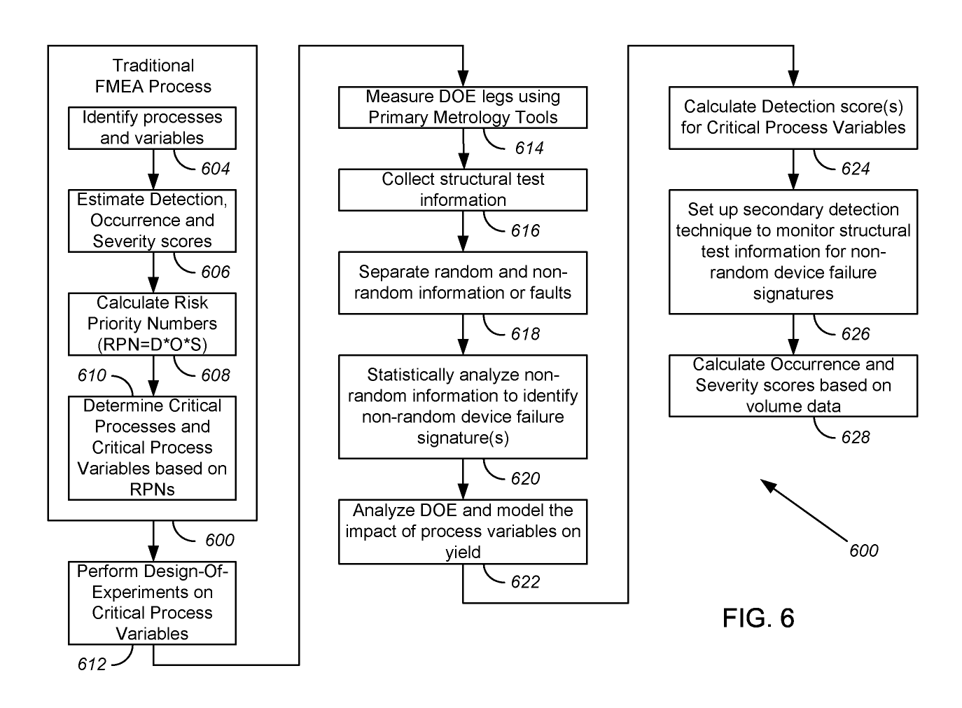

FIG. 6 illustrates use of the method 100 in a first exemplary method 600 for improving a FMEA process. The method 600 begins with the performance of a traditional FMEA process 602, which traditional FMEA process 602 begins with an identification of production processes and their variables (in block 604). For those processes and variables that are believed to be critical to high yield (or for all of the processes and variables), specification limits are estimated, and Detection, Occurrence and Severity scores are estimated (at block 606). The Detection, Occurrence and Severity estimates for each variable are then multiplied to yield Risk Priority Numbers (RPNs, at block 608). RPNs are a common way to rank the criticality of process variables in an FMEA process, and such a ranking is undertaken in block 610. Finally, the most critical processes are classified as “Critical Processes”, and the most critical process variables are classified as “Critical Process Variables” (at block 610).

Next, a Design-Of-Experiments (DOE) is performed on the Critical Process Variables (at block 612). The DOE is used to measure the actual fail rates attributable to the Critical Processes when their variables are pushed to their specification limits. In some embodiments, the DOE may be implemented in accord with the previously-described “proactive” implementation of the method 100 or system 200. DOE material may comprise, for example, wafers or devices manufactured using different lithography exposure times.

In accord with the DOE approach, the DOE material is processed to the end of the line (or to an appropriate metrology point or structural test stage), and the Critical Process Variables are measured for all legs of the DOE (at block 614). The Critical Process Variables are measured using the Primary Metrology Tools for the manufacturing process, such as in-line electrical or optical inspection equipment.

The DOE material is also tested using structural test methods, and structural test information is collected (at block 616). Identified faults may then be localized to two- or three-dimensional locations and analyzed for non-random behavior. As part of this analysis, structural test information may be separated into random and non-random (e.g., systematic) information or faults (at block 618), and the non-random information may be statistically analyzed to identify at least one non-random device failure signature within the structural test information (at block 620). The legs of the DOE are then compared to the random and non-random components of the yield loss using statistical tools such as the “t-test”, the “F-test”, Taguchi techniques, Shannon techniques or other statistical techniques designed to quantify the results of a DOE. These techniques provide a model of the impact of process variables on yield (at block 622).

Finally, the model is used to calculate the actual failure rates for the various legs of the DOE, and these failure rates are correlated to the process variables (e.g., probable root causes) measured on the Primary Metrology Tools (at block 624). This correlation data may then be used, for example, to 1) update the in-line specifications for the process variables, and 2) update the Detection scores for the process variable. In some embodiments, an updated Detection score can be calculated by 1) determining a first failure rate attributable to variation in a process variable, wherein the first failure rate corresponds to failures detected by a first set of one or more metrology tools (e.g., failures detected by the Primary Metrology Tools), and 2) determining a second failure rate attributable to variation in the process variable, wherein the second failure rate corresponds to failures identified by one or more non-random device failure signatures that have been correlated with the process variable (e.g., signatures based on structural test information). A FMEA Detection score can then be generated for the process variable as a ratio of the first and second failure rates.

Next, a secondary detection technique is set up to monitor items of structural test information obtained for additional semiconductor devices, such as additional semiconductor devices produced during high volume production. The monitoring serves to identify instances of non-random device failure signatures that have already been correlated with variation in process variables (at block 626). The identified instances of the non-random device failure signatures are then used to update the appropriate Occurrence and Severity scores in the FMEA process (at block 628). In some embodiments, an updated Occurrence score can be calculated as the probability that an excursion or process drift will occur. An updated Severity score can be calculated as the probability of yield loss. This enables the calculation of a FMEA Risk Priority Number (RPN) as: a percentage yield loss; a fraction; or a monetary cost.

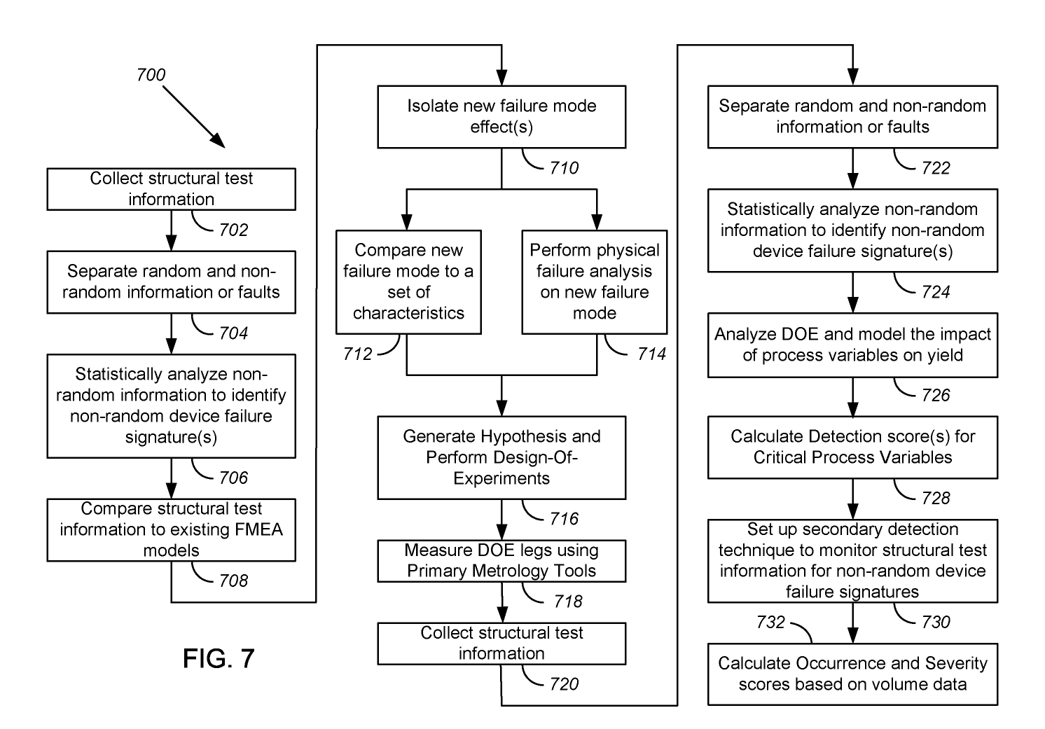

FIG. 7 illustrates use of the method 100 in a second exemplary method 700 for improving a FMEA process. The method 700 can be considered a “continuous improvement” FMEA process. The continuous improvement approach may be used to detect and analyze new failure mode effects, and then update the FMEA analysis and control plan. In some cases, and by way of example, new failure mode effects may result from an interaction between process variables that was not understood during the initial FMEA process. In other cases, and by way of example, new failure mode effects may results from an interaction between a manufacturing process and a particular semiconductor device. The large numbers of design rules and design-for-yield guidelines lead to a greater variety in the fit between devices and processes.

In accord with the method 700, structural test information is collected at block 702, separated into random and non-random yield loss at block 704, and statistically analyzed to identify at least one non-random signature at block 706. The root cause of failing material is then analyzed and compared to existing FMEA models (e.g., FMEA models derived from execution of the proactive method 600) at block 708. Failures that can be explained using the existing models are then removed from the data set, thereby isolating the new failure mode effects at block 710.

At block 712, the new failure mode is compared to a set of characteristics, and a hypothesis that explains the failure mode effects is generated (at block 716). A DOE approach may then be used to test the hypothesis and, when necessary, update the hypothesis, until a model for the failure mode effects can be produced.

The characteristics to which the new failure mode effects are compared may comprise, for example, fault models such as stuck-at faults, delay faults, blocked chain faults, Iddq faults, radio frequency (RF) faults, analog faults, functional faults, parametric faults or AC faults. The characteristics may also include the occurrence frequency of the faults, such as random and non-random classifications. The characteristics may also include the ease of fault detection using optical or e-beam inspection techniques. For example, faults may be classified as visible faults or non-visible faults. The characteristics may also include the proximities of faults to locations of known sensitivity to process variation. For example, faults may be classified as occurring near lithography hot-spots, chemical-mechanical planarization (CMP) hot-spots, strain hot-spots, or sensitive locations based on another model of process capability or device behavior. Still further, the characteristics may include the proximity of the fault to a location of known sensitivity to a design rule or design for yield hot-spot. For example, faults may be classified as occurring near a design rule violation, or at an extreme value that is still within the design rules.

Alternately, at block 714, a subset of the faults is localized and analyzed using electrical and/or physical failure analysis, until a new hypothesis is generated to explain the faults.

At block 716, a DOE approach is used to test and update the hypothesis until a model for the new failure mode can be produced. The remaining steps 718, 720, 722, 724, 726, 728, 730, 732 of the method 700 are similar to the corresponding steps 614, 616, 618, 620, 622, 624, 626, 628 in method 600 (FIG. 6).

The new failure modes detected using the method 700 can be used to update the FMEA analysis and control plan.

In some embodiments, the FMEA ratings for Detection, Occurrence and Severity may also be calculated for various design blocks, library elements and other design elements. The FMEA models are then be updated to include terms for physical layout, physical properties and other aspects of the design geometries and styles. These models can bee used to selectively improve the design or the design process.

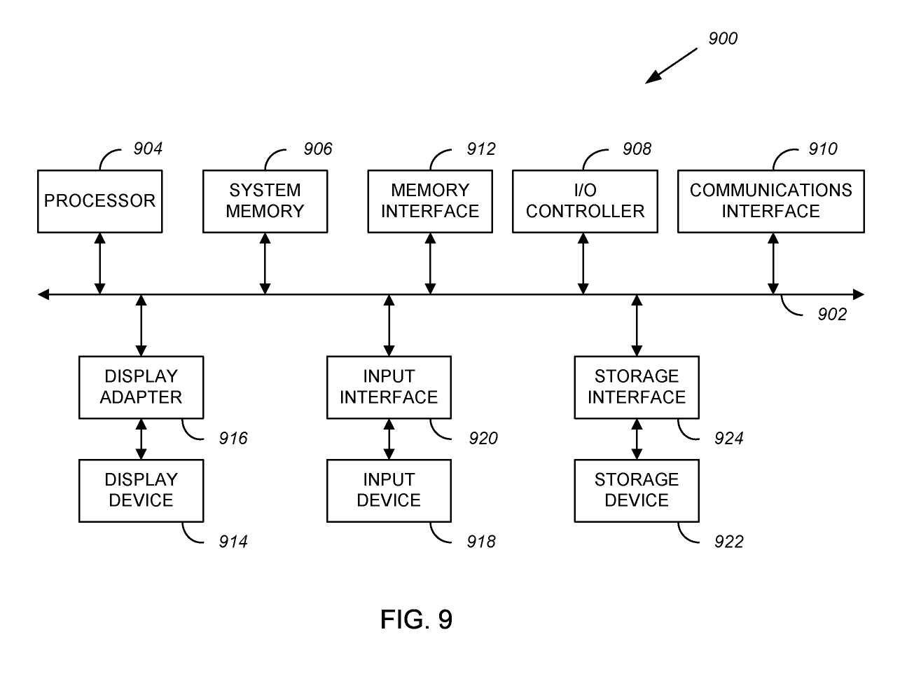

FIG. 9 provides a block diagram of an exemplary computer system 900 that can be used to implement the systems and methods described herein. The computer system 900 generally represents any single or multi-processor computing device that is capable of executing single-threaded or multi-threaded applications. The computer system 900 may include a communication infrastructure 902 that interconnects the major subsystems of the computer system 900. The communication infrastructure 902 generally represents any form or structure that is capable of facilitating communication between one or more electronic components; including, for example, a communication bus (e.g., ISA, PCI, PCI-E, AGP, etc.) or a network.

As illustrated in FIG. 9, the exemplary computer system 900 may comprise a processor 904, a system memory 906, an Input/Output (I/O) controller 908, a communication interface 910, and a memory interface 912. The processor 904 generally represents any type or form of CPU or other computing device that is capable of executing instructions and processing data. The instructions provided to the processor 904 may cause the processor 904 to perform the steps of the methods 100, 600 or 700, or cause the processor 904 to implement the subcomponents 202, 204, 206, 208, 210, 212 of the system 200. The instructions provided to the processor 904 may be instructions from a software application or module, and the methods and systems disclosed herein may be implemented as instructions in one or more of the software applications or modules. The processor 904 may execute, or assist in executing, various of the methods described herein. For example, the processor 904 may execute, and/or be a means for executing, either alone or in combination with other elements, one or more of the actions or functions performed by the methods or systems described herein. The processor 904 may also perform and/or be a means for performing various other steps or processes described and/or illustrated herein.

The system memory 906 generally represents any type or form of storage device or non-transitory computer-readable medium capable of storing data and/or other computer-readable instructions. Examples of system memory 906 include, without limitation, a random access memory (RAM) unit, a read only memory (ROM) unit, a flash RAM unit, or any other suitable memory device. In certain embodiments, the system memory 906 may be used, for example, to store data. The I/O controller 908 generally represents any type or form of computer board or module that is capable of coordinating and/or controlling the input and output functions of a computing device. The I/O controller 908 may be used, for example, to perform and/or be a means for performing, either alone or in combination with other elements, one or more of the actions or functions performed by the methods or systems described herein. The I/O controller 908 may also be used to perform and/or be a means for performing other steps and features set forth herein.

The communication interface 910 generally represents a communication device capable of facilitating communication between the exemplary computer system 900 and an additional device or devices. For example, in certain embodiments, the communication interface 910 may interconnect the computer system 900 with one or more components of a semiconductor test system (e.g., ATE or BIST hardware), as well as with a private or public network comprising additional computer systems. Examples of the communication interface 910 include, without limitation, a network interface (such as a network interface card), a wireless card, a modem, a communications port (such as a USB or Firewire port), and any other suitable interface. In at least one embodiment, the communication interface 910 may provide a direct connection to a remote server via a direct network link to the Internet. The communication interface 910 may also provide a connection through, for example, an Ethernet connection, a modem, a digital cellular telephone connection, a BLUETOOTH network, an IEEE 802.11x wireless network, a digital satellite data connection, or any other suitable connection.

The communication interface 910 may allow the computer system 900 to engage in distributed or remote computing. For example, the communication interface 910 may receive instructions from a remote computer, or communication interface 910 may send instructions to a remote computer or test system for execution. Accordingly, the communication interface 910 may perform and/or be a means for performing, either alone or in combination with other elements, one or more of the actions or functions of the methods or systems described herein. The communication interface 910 may also be used to perform and/or be a means for performing other steps and features set forth in the instant disclosure.

The memory interface 912 generally represents any type or form of device that is capable of allowing software and data to be transferred between a storage device and other components of the computer system 900. For example, memory interface 912 may comprise a cartridge interface, a memory socket, or a disk drive. Memory interface 912 may also be a floppy drive, an optical disk drive, a flash interface, or any other type of memory interface. In certain embodiments, the memory interface may perform and/or be a means for performing, either alone or in combination with other elements, one or more of the actions or functions performed by the methods or systems described herein. The memory interface 912 may also be used to perform and/or be a means for performing other steps and features described and/or illustrated herein.

As illustrated in FIG. 9, the computer system 900 may also comprise at least one display device 914 that is coupled to the communication infrastructure 902 via a display adapter 916. The display device 914 generally represents any type or form of device that is capable of visually displaying information forwarded by the display adapter 916. Similarly, the display adapter 916 generally represents any type or form of device that is configured to forward graphics, text, and other data from communication infrastructure 902 (or from a frame buffer, as known in the art) for display on the display device 914. Examples of the display device 914 include, without limitation, CRT monitors, LCD screens, plasma screens, video projectors, and the like.

As illustrated in FIG. 9, exemplary computer system 900 may also comprise at least one input device 918 coupled to communication infrastructure 902 via an input interface 920. Input device 918 generally represents any type or form of user input device capable of providing input, either computer or human generated, to exemplary computer system 900. Examples of input device 918 include, without limitation, a keyboard, a pointing device, a speech recognition device, or any other input device. In at least one embodiment, input device 918 may perform and/or be a means for performing, either alone or in combination with other elements, one or more of the receiving, accessing, determining, verifying, modifying, preventing, creating, encrypting, decrypting, password-protecting, limiting, providing, terminating, calculating, applying, generating, transmitting, communicating, and/or storing steps described herein. Input device 1018 may also be used to perform and/or be a means for performing other steps and features set forth in the instant disclosure.

As illustrated in FIG. 9, the exemplary computer system 900 may also comprise a storage device 922 that is coupled to the communication infrastructure 902 via a storage interface 924. The storage device 922 generally represents any type or form of storage device or medium that is capable of storing data and/or other computer-readable instructions. For example, the storage device 922 may be a magnetic disk drive (e.g., a so-called hard drive), a floppy disk drive, a magnetic tape drive, an optical disk drive, a flash drive, or the like. In certain embodiments, the storage device 922 may be configured to read from and/or write to a removable storage unit that is configured to store computer software, data, or other computer-readable information. Examples of suitable removable storage units include, without limitation, a floppy disk, a magnetic tape, an optical disk, a flash memory device, or the like. The storage device 922 may also comprise other similar structures or devices for allowing computer software, data, or other computer-readable instructions to be loaded into the computer system 900. For example, the storage device 922 may be configured to read and write software, data, or other computer-readable information. The storage device 922 may also be a part of the computer system 900 or may be a separate device that is accessed through other interface systems. In certain embodiments, the storage device 922 may be used, for example, to perform and/or be a means for performing, either alone or in combination with other elements, one or more of the actions or functions of the methods or systems described herein. The storage device 916 may also be used to perform and/or be a means for performing other steps and features set forth in the instant disclosure.

In certain embodiments, the computer system 900 may be any kind of computing device, including a server, a blade farm or a network appliances. The computer system 900 may also be any type of device that is configured to execute the functions and modules described and/or illustrated herein. The computer system 900 may be a source computer, a destination computer, a server, or any other computing device discussed herein. The operating system provided on computer system 900 may be WINDOWS, UNIX, Linux, or any other operating system or platform. The computer system 900 may also support a number of Internet access tools; including, for example, an HTTP-compliant web browser having a JavaScript interpreter, such as Netscape Navigator, Microsoft Internet Explorer, or other similar navigators.

Many other devices or subsystems may be connected to the computer system 900. Conversely, all of the devices shown in FIG. 9 need not be present to practice the embodiments described and/or illustrated herein. The devices and subsystems referenced above may also be interconnected in different ways from that shown in FIG. 9. Indeed, the computer system 900 may use any number of software, firmware, and/or hardware configurations. For example, one or more of the functions or subcomponents disclosed herein may be encoded as a computer program (also referred to as computer software, software applications, computer-readable instructions, or computer control logic) and stored in a computer-readable medium. The computer-readable medium containing the computer program may then be loaded into the computer system 900 using a removable storage drive, or downloaded to the computer system 900 via the communication interface 910 over a communication path, such as the Internet or other network. All or a portion of the computer program stored on the computer-readable medium may then be stored in system memory 906 and/or various portions of the storage device 922. According to certain embodiments, a computer readable medium may be an optical storage device, a magnetic storage device, or any other physical storage device capable of storing computer readable instructions. When executed by the processor 904, a computer program loaded into the computer system 900 may cause the processor 904 to perform and/or be a means for performing the actions or functions of the methods or systems described herein. Additionally or alternatively, one or more of the exemplary embodiments described and/or illustrated herein may be implemented in firmware and/or hardware. For example, one or more of the exemplary embodiments disclosed herein may be implemented using various hardware components such as, for example, application specific integrated circuits (ASICs).

The preceding description has been provided to enable others skilled in the art to best utilize various aspects of the exemplary systems, methods and apparatus described herein. This exemplary description is not intended to be exhaustive or to be limited to any precise form disclosed. Many modifications and variations are possible without departing from the spirit and scope of the instant disclosure. It is desired that the embodiments described herein be considered in all respects illustrative, and not restrictive, and that reference be made to the appended claims and their equivalents for determining the scope of the instant disclosure.

While the foregoing disclosure sets forth various embodiments using specific block diagrams, flowcharts, and examples, each block diagram component, flowchart step, operation and/or component described and/or illustrated herein may be implemented, individually and/or collectively, using a wide range of hardware, software, or firmware (or any combination thereof) implementations.

The foregoing disclosure also describes embodiments including components contained within other components. Such architectures are merely examples, and many other architectures can be implemented to achieve the same functionality. For example, one or more of the components or devices described and/or illustrated herein may be combined into a single component or device and/or separated into a plurality of components or devices. Similarly, the process parameters and sequences of steps described and/or illustrated herein are given by way of example only and can be varied as desired. For example, while the steps illustrated and/or discussed herein may be shown or discussed in a particular order, these steps do not necessarily need to be performed in the order illustrated or discussed. In addition, the various exemplary methods described and/or illustrated herein may omit one or more of the steps described or illustrated herein or include additional steps in addition to those described or illustrated.

Furthermore, while various embodiments have been described and/or illustrated herein in the context of fully functional computer systems, one or more of the exemplary embodiments described and/or illustrated herein may be capable of being distributed as a program product in a variety of forms, regardless of the particular type of signal storage media used to actually carry out the distribution. Examples of signal storage media include recordable media such as floppy disks and CD-ROMs, transmission type media such as digital and analog communications links, as well electronic storage media, magnetic storage media, optical storage media, and other signal storage distribution systems.

In addition, one or more of the embodiments described and/or illustrated herein may be implemented using software modules and scripts that perform certain tasks. The software modules and scripts discussed herein may include script, batch, or other executable files. In addition, these software modules and scripts may be stored on a machine-readable or computer-readable storage medium, such as a disk drive. In some embodiments, the modules and scripts can be stored within a computer system memory to configure the computer system to perform the functions of the module. One or more of the steps discussed herein may be automated by a computer. In some embodiments, all of the steps performed by a module or application may be automated by a computer.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A method for statistically analyzing structural test information to identify at least one yield loss mechanism, the method comprising:
executing a plurality of instructions on a computer system, the executed instructions causing the computer system to perform the steps of,
identifying potential root causes for items of structural test information obtained for a plurality of semiconductor devices;
statistically analyzing the items of structural test information to identify at least one non-random device failure signature within the items of structural test information; and
identifying from the potential root causes a probable root cause for at least a first of the at least one non-random device failure signature.

2. The method of claim 1, wherein the items of structural test information include quantitative structural test information.

3. The method of claim 1, wherein the items of structural test information include qualitative structural test information.

4. The method of claim 1, wherein identifying potential root causes for the items of structural test information comprises:
identifying cones of logic that drive failed scan chain elements.

5. The method of claim 4, wherein identifying potential root causes for the items of structural test information further comprises:
determining physical locations of the identified cones of logic.

6. The method of claim 1, wherein the plurality of semiconductor devices comprises a plurality of semiconductor die, and wherein:
identifying potential root causes for the items of structural test information obtained for the plurality of semiconductor devices comprises identifying die-level potential root causes for the items of structural test information.

7. The method of claim 1, wherein the plurality of semiconductor devices comprises multiple semiconductor die devices, and wherein:
identifying potential root causes for the items of structural test information obtained for the plurality of semiconductor devices comprises identifying both die-level and package-level potential root causes for the items of structural test information.

8. The method of claim 1, further comprising:
automatically updating a test program for the semiconductor device to include tests for further evaluating the probable root cause for the at least first of the at least one non-random device failure signature.

9. The method of claim 1, wherein statistically analyzing the items of structural test information comprises separating non-random device failure signatures from random device failure signatures.

10. The method of claim 1, wherein statistically analyzing the items of structural test information comprises correlating quantitative items of the structural test information, the quantitative items obtained for multiple observation points within the plurality of semiconductor devices.

11. The method of claim 1, wherein statistically analyzing the items of structural test information comprises applying Chi-square techniques to qualitative items of the structural test information, the qualitative items obtained for multiple observation points within the plurality of semiconductor devices.

12. The method of claim 1, further comprising:
executing the plurality of instructions in real-time, upon collection of the items of structural test information.

13. The method of claim 1, wherein the executed instructions further cause the computer system to perform the steps of:
using a particular one of the at least one non-random device failure signature to search for at least one other semiconductor device associated with the particular one of the at least one non-random device failure signature;
identifying production process steps or variations that are common to the semiconductor devices associated with the particular one of the at least one non-random device failure signature; and
identifying the probable root cause, for the particular one of the at least one non-random device failure signature, from among the common production process steps or variations.

14. The method of claim 1, wherein the potential root causes include a number of variations in a design of the plurality of semiconductor devices.

15. The method of claim 1, wherein the potential root causes include a number of variations in a process variable for the plurality of semiconductor devices.

16. The method of claim 15, wherein identifying the probable root cause for the at least first of the at least one non-random device failure signature, from the potential root causes, comprises:
correlating at least one non-random device failure signature with a variation in the process variable.

17. The method of claim 15, wherein the executed instructions further cause the computer system to perform the steps of:
determining a first failure rate attributable to variation in the process variable, the first failure rate corresponding to failures detected by a first set of one or more metrology tools;
determining a second failure rate attributable to variation in the process variable, the second failure rate corresponding to failures identified by the at least one non-random device failure signature that is correlated with variation in the process variable; and
generating a failure mode effects analysis (FMEA) Detection score for the variation in the process variable, as a ratio of the first failure rate and the second failure rate.

18. The method of claim 17, wherein the executed instructions further cause the computer system to perform the steps of:
monitoring items of structural test information obtained for additional semiconductor devices, the monitoring serving to identify instances of the at least one non-random device failure signature correlated with variation in the process variable; and
updating FMEA Occurrence and Severity scores based on the identified instances of the at least one non-random device failure signature correlated with the variation in the process variable.

19. The method of claim 16, wherein the executed instructions further cause the computer system to perform the steps of:
in response to correlating the at least one non-random device failure signature with the variation in the process variable, setting at least one specification limit for the process variable.

20. The method of claim 1, wherein the executed instructions further cause the computer system to perform the steps of:
displaying, on a graphical user interface, the probable root cause for the at least first of the at least one non-random device failure signature.

21. A system for statistically analyzing structural test information to identify at least one yield loss mechanism, the system comprising:
a computer system having,
at least one failure mechanism analysis engine having a structural test information input and a root cause output, each of the at least one failure mechanism analysis engine configured to identify potential root causes for items of structural test information obtained for a plurality of semiconductor devices;
a process-level statistical analysis engine configured to statistically analyze the items of structural test information and identify at least one non-random device failure signature within the items of structural test information; and
a probable root cause identification engine configured to identify a probable root cause for at least a first of the at least one non-random device failure signature.

22. The system of claim 21, further comprising an automated test equipment (ATE) system, in communication with the computer system to pass the items of structural test information to the computer system.
